(19) United States
(12) Patent Application Publication
(10) Pub. No.: US 2007/0074610 A1
(43) Pub. Date: Apr. 5, 2007

(54) Circlip pliers

(76) Inventor: Andreas Heinsohn, Wuppertal (DE)

Correspondence Address: Martin A Farber, 866 United Nations Plaza Suite 473, New York, NY, 10017, US

(21) Appl. No.: 10/547,661

(22) PCT Filed: Mar. 3, 2004
(86) PCT No.: PCT/EP04/02123

§ 371 Date: Sep. 25, 2006

(30) Foreign Application Priority Data
Mar. 5, 2003 (DE) 103 10 280.9
Mar. 13, 2003 (DE) 103 10 918.8

(51) Int. Cl. B25B 7/12; B25B 25/00; B25B 11/00

(52) U.S. Cl. 81/302; 81/485; 81/486

(57) ABSTRACT

Circlip pliers (1) have two pliers limbs (2), which are formed for gripping, and two pliers tips (5), and insertion tips (6) for introduction into actuating eyelets (7) of a circlip (8) being provided on the pliers tips (5). The insertion tips are rooted in a contact surface (9) of the pliers tips (5), wherein, in the unactuated state of the pliers, longitudinal axes (x-x) of the insertion tips (6) enclose an acute angle (α) with one another, and the planar contact surface (9) likewise forms an acute angle (β) with a perpendicular (y-y) to such a longitudinal axis (x-x), and wherein the contact surfaces (9) of the pliers tips (5) form an obtuse angle with one another.

The invention relates to a circlip pliers comprising two pliers limbs, which are formed for gripping, and two pliers tips, insertion tips for introduction into actuating eyelets of a circlip being provided on the pliers tips.

A circlip pliers is known for example from DE-U 296 09 423.

An object of the invention is to form a circlip pliers with a more sure grip with respect to the circlip by simple means.

For this purpose, it is proposed in first instance to provide a circlip pliers comprising two pliers limbs, formed for gripping, and two pliers tips, insertion tips for introduction into actuating eyelets of a circlip being provided on the pliers tips, which insertion tips are rooted in a contact surface of the pliers tips and, in the actuated state of the pliers, longitudinal axes of the insertion tips forming an acute angle with one another and the planar contact surface likewise forming an acute angle with a perpendicular to such a longitudinal axis in such a way that the contact surfaces of the pliers tips form an obtuse angle with one another.

The somewhat swept-back insertion tips have the effect that the circlip is held against slipping-off right from the outset. When the circlip is made to spread as it is withdrawn, it slides against the planar contact surfaces of the pliers tips while being supported over a relatively wide area. This results in planar support without any helical turning. The support finally becomes complete, since the contact surfaces of the planar tips increasingly extend parallel to the planar circlip, at least when the withdrawal of the circlip is achieved. In this position, the insertion tips diverge even more and produce as it were a capturing effect with respect to the actuating eyelets of the circlip. With respect to the outline of the contact surfaces in which the insertion tips are rooted, an elongate, rounded rectangular shape is preferred. The longer extent lies in the plane of pivoting of the pliers limbs. On the one hand, this allows the desired flat configuration to be achieved, which, on the other hand, allows work to be carried out at installation locations where access is difficult. Another advantageous feature of the invention is that the angle of the insertion tips lies in the range from 3° to 7° and the angle of the contact surface lies in the range from 6° to 10°. Upward or downward deviations may be of benefit, depending on the size of the tool.

Furthermore, the invention proposes a circlip pliers comprising two pliers limbs and two pliers tips, insertion tips which have a planar end face being provided on the pliers tips, which pliers is characterized in that the end face forms an acute angle with a perpendicular to a longitudinal axis of an insertion tip, the angle of an insertion tip sloping down toward a longitudinal center axis of the pliers. This prevents the insertion tips from coming out of the actuating eyelets. There is as it were an escape clearance with respect to the workpiece, created by the sloping-back profile of the end face. The importance of this way of forming the tip is evident in that it allows for the fact that, when conventional insertion tips are introduced into a circlip, in particular with the latter lying directly against a workpiece, the radius of movement has the effect that, during opening, the corner of the end face that is on the inside in respect of the movement forces the insertion tip as a whole out of the eyelet to some extent. The force transmission of the opposite corner of the end face is forced back into the portion of the opening of the actuating eyelet that is in the middle or even on the entry side. This correspondingly results in poorer retention, which leads to the circlip flying off and can even contribute to the undesired twisting of the circlip during opening that was mentioned above. This problem is remedied by the solution according to the invention. In the force transmission phase, the end face extends virtually parallel to the plane of the circlip or that of the workpiece. The divergence of the insertion tips in this case provides a drawing-together force. An additional measure for providing a sure grip is that the insertion tips have a roughness-increasing coating, for example a diamond coating (cf. the cited utility model). Finally, it is also proposed that, in the unactuated state of the pliers, the end faces of the two insertion tips form an obtuse angle with one another. This provides even greater freedom from tipping over without a levering-off effect.

The subject matter of the invention is explained in more detail below on the basis of an exemplary embodiment illustrated in the drawings, in which,

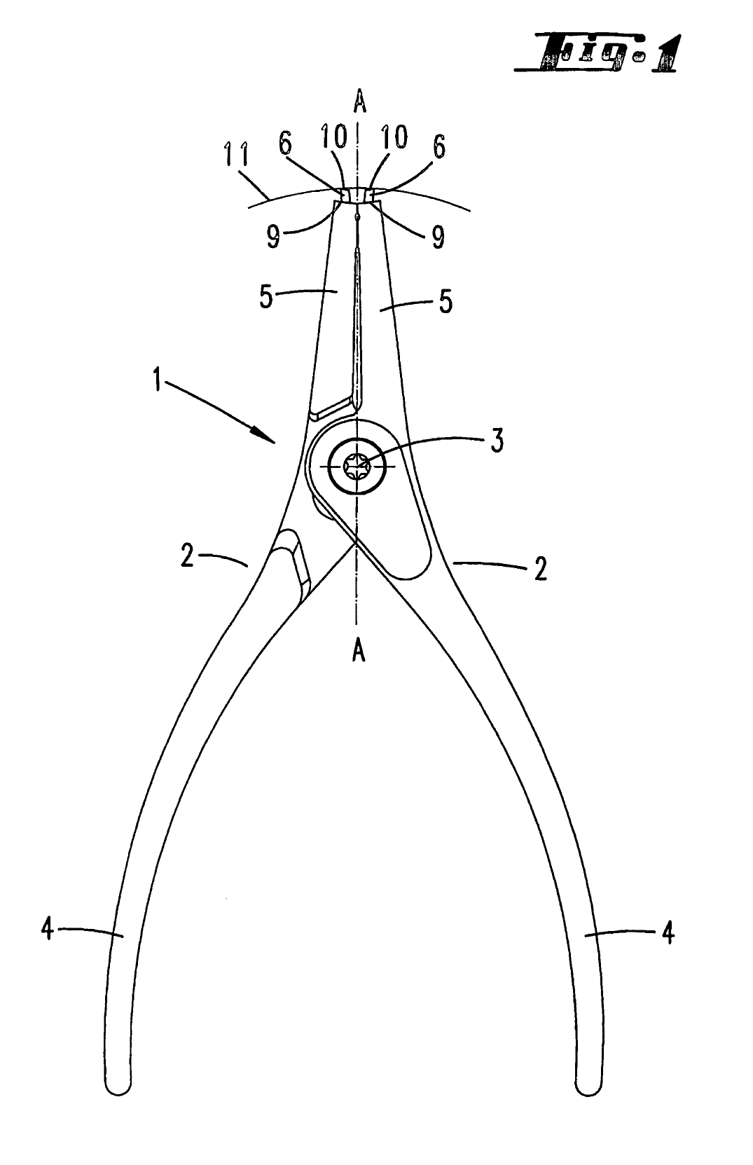

FIG. 1 shows the circlip pliers in side view, to be precise in unactuated state,

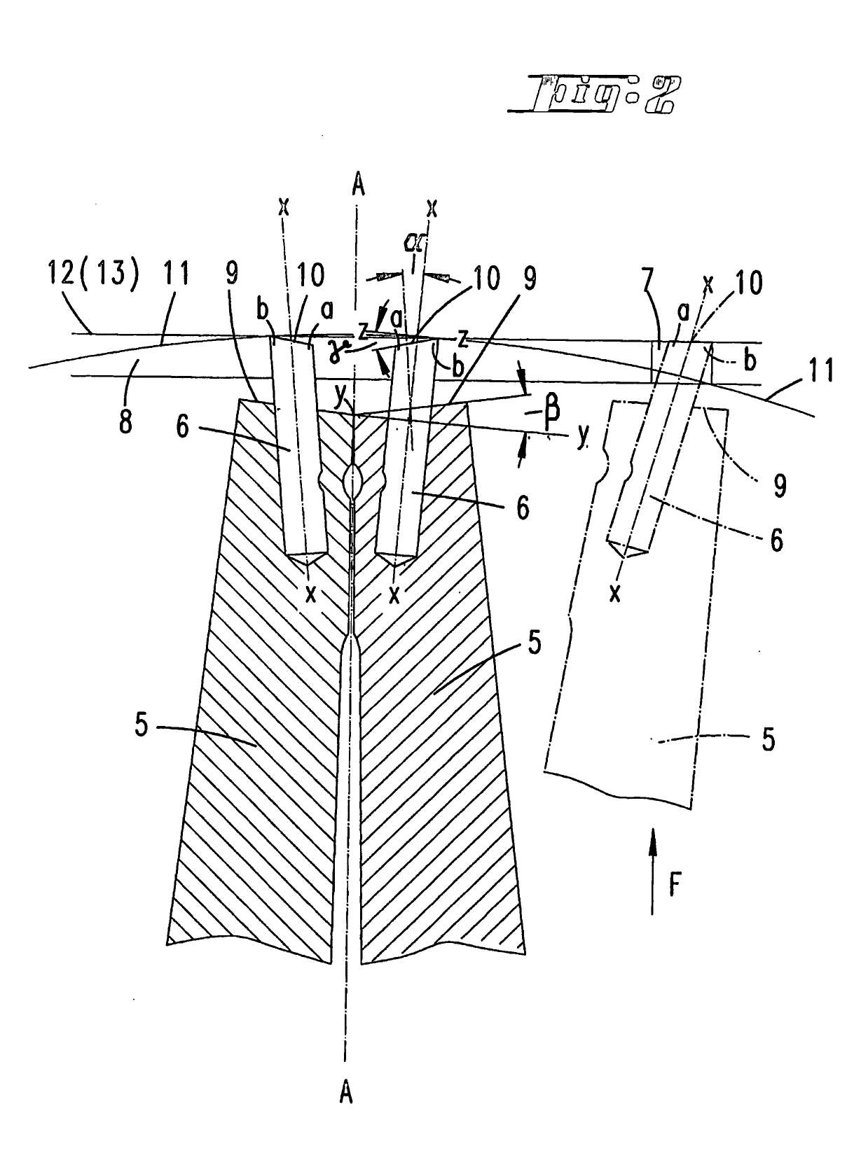

FIG. 2 shows the region of the pliers tips in section, together with a geometrical auxiliary construction to aid understanding,

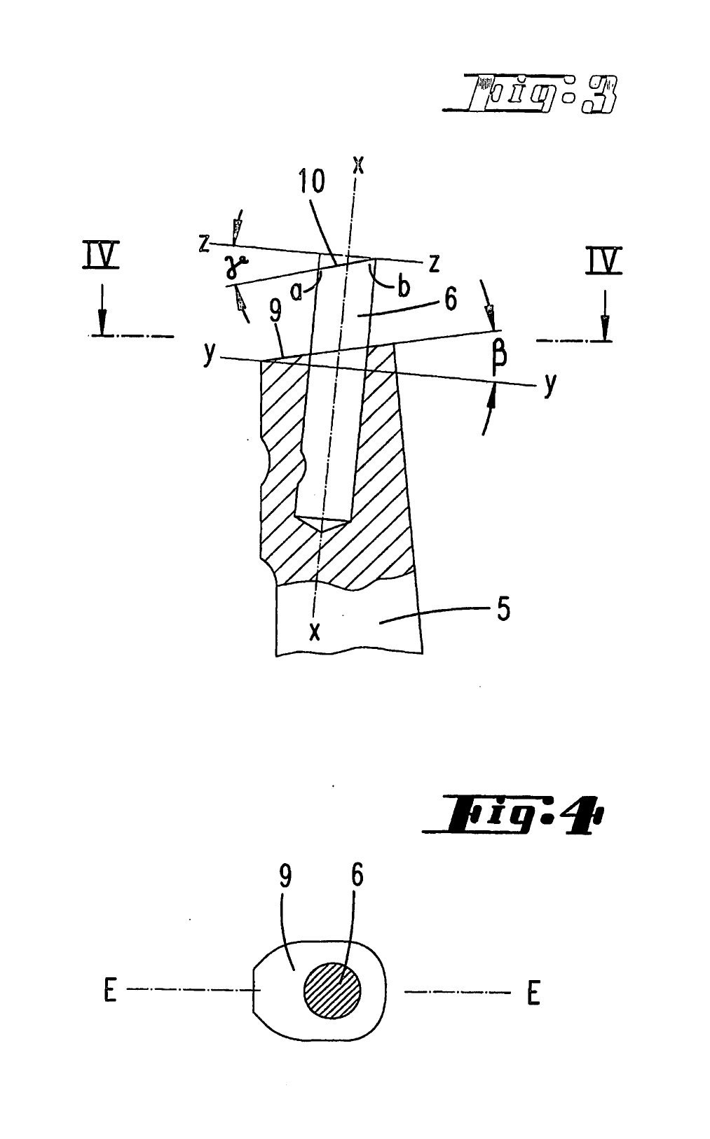

FIG. 3 shows one pliers tip on its own, likewise shown in section,

FIG. 4 shows the section along the line IV-IV in FIG. 3,

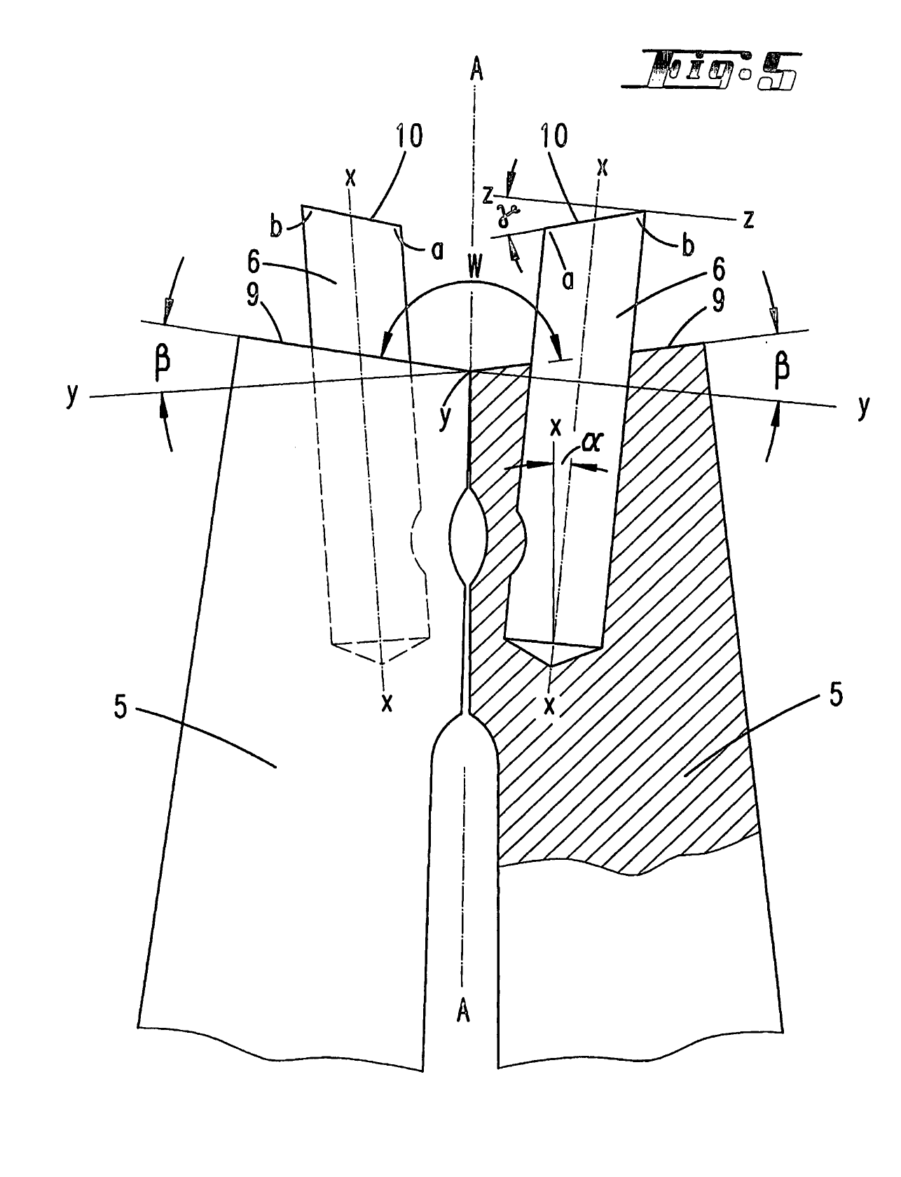

FIG. 5 shows an enlargement of an extract from FIG. 2, though only showing one of the two pliers tips in section,

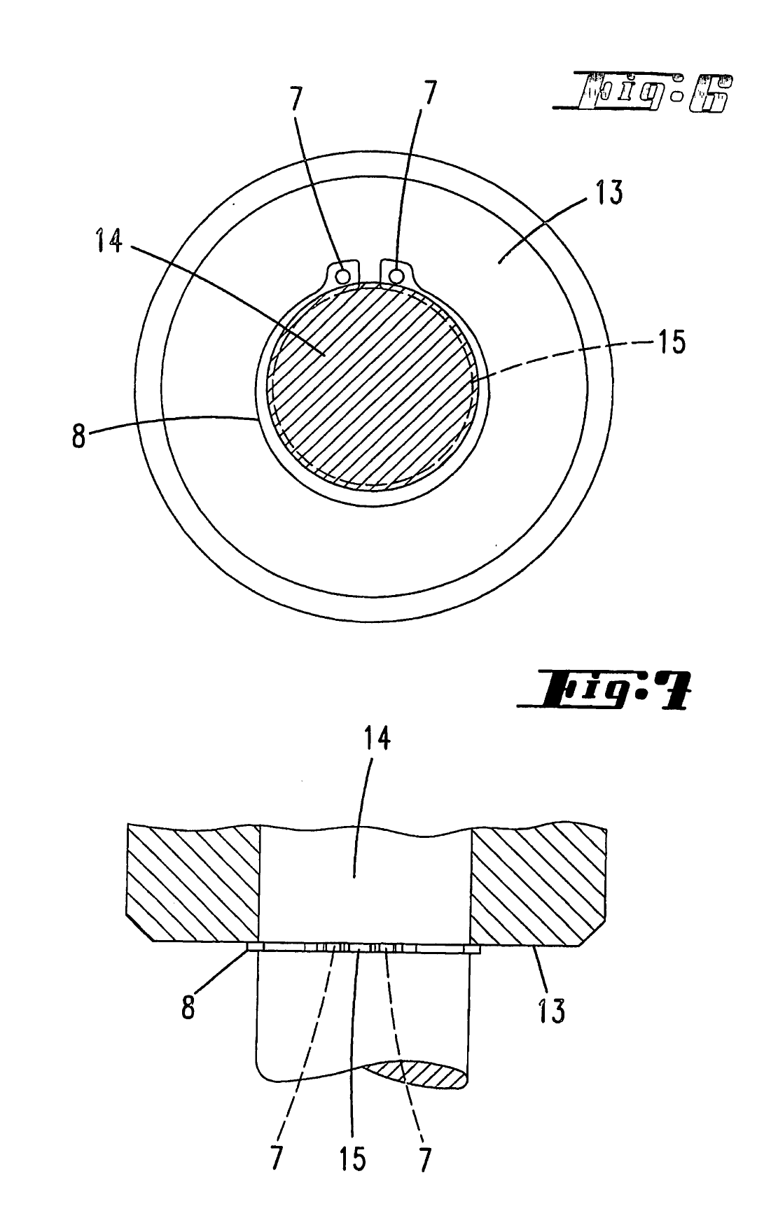

FIG. 6 shows the circlip positioned on a workpiece,

FIG. 7 shows the same in longitudinal section.

The circlip pliers 1 that is represented comprises two pliers limbs 2. These are connected to one another by means of a pivot pin 3.

The pliers limbs 2, formed for gripping, have a manual actuating portion and a functional portion.

The manual actuating portion comprises grips 4. The functional portion is provided by pliers tips 5 similar to pliers jaws. The pliers tips 5 are of an elongate configuration and taper away from the pivot pin. In the unactuated state, they lie against one another. The closed position in question is brought about by a spring. This is located in a spring chamber in the region of the pivot pin 3.

The pliers tips 5 continue into insertion tips 6, which are significantly reduced in cross-section. The insertion tips 6 can be introduced into actuating eyelets 7 of a circlip 8 while the circlip pliers 1 are opened slightly.

The basically cylindrical insertion tips 6 consist of piano wire. They are fitted in matching receptacles in the free ends of the pliers tips 5 and thereby project beyond planar contact surfaces 9 of the pliers tips 5.

For fixing in the receptacles, grain-type displacements of the material of the pliers tips 5 may be effected from the outside, forcing material into niches or pockets of the roots of the insertion tips 6.

As can be gathered from the drawing, the insertion tips 6 are aligned such that they diverge outward. It can be seen that, in the unactuated state of the circlip pliers 1, the longitudinal axes x-x of the insertion tips enclose an angle α with one another. The angle is chosen such that the insertion tips 6 can still be easily introduced into the bore-like holes, i.e. actuating eyelets 7.

The angle of the insertion tips 6 lies in the range from 3° to 7°.

In this case, the planar contact surface 9 likewise forms an acute angle β with a perpendicular y-y to such a longitudinal axis x-x. As is evident, the contact surfaces 9 of the pliers tips 5 form an obtuse angle W of about 160°. When the circlip pliers are opened, this becomes an angle of 180° as the opening width is reached. This means parallel flatness with respect to the circlip 8. There is flush engagement of the circlip or the like with the tool over a relatively large area and without any use. The large area around the actuating eyelets 7 has a correspondingly advantageous effect. The acute angle β of the contact surface 9 lies in the range from 6° to 10°. As can be gathered from the drawing (cf. FIG. 4), the contact surfaces 9 are of an oblong configuration. The longer extent lies in the plane of pivoting E-E of the pliers tips 5.

The corner regions of the oblong contact surface 9 are convexly rounded or go over into a trapezoidal contour toward the longitudinal center axis A,A of the circlip pliers 1, forming a flank angle of about 90°. The fact that the circlip 8 can be held so securely and the relative movement in relation to the actuating eyelets 7 of the circlip 8 is reduced or eliminated has the effect not least of also advantageously influencing the fatigue strength of the tool, in particular when the circlips 8 are opened by force. In addition, an overall improvement is also achieved by the measure that the insertion tips 6 have a roughness-increasing coating, for example a diamond coating.

The further measure comprises a special configuration of the insertion tips 6. This comprises its end face 10 having an oblique slope. This is embodied by the end face 10 forming an acute angle γ with a perpendicular z-z to the longitudinal axis x-x of the insertion tip 6, the angle or the surface of the insertion tip 6 sloping down toward the longitudinal center axis A,A of the circlip pliers 1. The end faces 10 can then be in planar alignment in the unactuated state of the pliers. However, greater beveling (cf. FIGS. 2 and 5) is preferred. As the circlip pliers 1 is opened, the corner a facing the longitudinal center axis A-A recedes relatively, increasingly in the direction of the hinge bolt 3. This means that there is no twisting effect, with the result of the insertion tips 6 coming out of the actuating eyelets 7 of the circlip 8. This also does not occur up to the customary opening angle of the circlip pliers 1.

A glance at FIGS. 1 and 2 makes it clear that the outer corners b of the beveled end face 10 run on an arcuate path 11, extending about the center of the pivot bolt 3. This illustrates the bevels well. The bevel sloping down toward the longitudinal center axis A,A is positioned, in the gripping phase, that is when there is force transmission, increasingly in the direction of arrow F into a fully tangential parallel to a horizontal line 12. This embodies the mating surface, provided by the end face of a bush 13, which is passed through by a pin or rod 14, which has a groove 15 for receiving the circlip 8 (cf. FIGS. 6 and 7).

FIG. 2 shows the one of the pliers tips 5 in dash-dotted lines, illustrating the parallel, fully-seated alignment of the end face 10 in relation to the corresponding bush 13. If, on account of other radii of the arc 11, a greater clearance action is required, the end faces 10 of the two insertion tips 6 may form an obtuse angle with one another in the unactuated state of the pliers.

As is evident, the corner b lies deep within the actuating eyelet 7. It acts by means of the spreading force like an anchor on the wall of the eyelet. The corner a does not exert any tilting point. This would be the case, as described, with an end face 10 that is not beveled, that is to say is exposed. This disadvantage is consequently overcome by simple means.

All disclosed features are (in themselves) pertinent to the invention. The disclosure content of the associated/attached priority documents (copy of the prior patent application) is also hereby incorporated in full in the disclosure of the application, including for the purpose of incorporating features of these documents in claims of the present application.

I claim:

1-5. (canceled)

6. Circlip pliers (1) comprising:
two pliers limbs, which are formed for gripping, and two pliers tips extending from respective ones of the limbs, and insertion tips for introduction into actuating eyelets of a circlip being provided on the pliers tips; wherein each of the insertion tips has a planar end face, and wherein the end faces of the insertion tips form in an unactuated state of the pliers an acute angle (γ) with a perpendicular (z-z) to a longitudinal axis (x-x) of an insertion tip, and wherein further an angle (γ) is sloping down toward a longitudinal center axis (A-A) of the pliers.

7. Circlip pliers according to claim 6, wherein the angle (γ) of the insertion tips is in the range from 3° to 7°.

8. Circlip pliers according to claim 6, wherein the insertion tips are routed in a planar contact surface and that the contact surface forms an acute angle (β) with a perpendicular (y-y) to a longitudinal axis (x-x) of an insertion tip.

9. Circlip pliers according to claim 8, wherein the angle (β) is in the range of 6° to 10°.

10. Circlip pliers according to claim 6, wherein the plier tips are to spread to lift out a circlip.

11. Circlip pliers according to claim 6, wherein in the unactuated state of the pliers the end faces of the two insertion tips form an obtuse angle with one another.

12. Circlip pliers according to claim 8, wherein the planar contact surfaces of the pliers tips form in the unactuated state of the pliers an obtuse angle (w).

13. Circlip pliers according to claim 6, wherein the insertion tips have a roughness-increasing coating.

14. Circlip pliers according to claim 13, wherein the coating is a diamond coating.
